(19) United States
(12) Patent Application Publication
(10) Pub. No.: US 2005/0190727 A1
(43) Pub. Date: Sep. 1, 2005

(54) Apparatus and method for extending radio messages in mobile communications

(75) Inventors: Gert-Jan Vanlieshout, Middlesex (GB); Himke Vandervelde, Middlesex (GB)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/993,104

(22) Filed: Nov. 19, 2004

(30) Foreign Application Priority Data
Nov. 19, 2003 (GB) 0326936.2

(51) Int. Cl. H04B 7/216

(52) U.S. Cl. 370/335

(57) ABSTRACT

A method of communicating via a cellular communications network, the method including communicating between a mobile terminal and a network element via radio messages according to a radio protocol, wherein the format of said radio messages includes a basic message portion corresponding to a first version of the radio protocol, and blocks of extension data each relating to a subsequent version of the radio protocol, and an extension container portion characterised in that said extension container portion is adapted to include extension blocks relating to more than one subsequent version of the radio protocol.

### PRIORITY

This application claims priority to an application entitled “An Apparatus and Method for Extending Radio Messages in Mobile Communications” filed in The Patent Office of the United Kingdom on Nov. 19, 2003 and assigned Serial No. 0326936.2, the contents of which are hereby incorporated by reference.

### BACKGROUND OF THE INVENTION

1. Field of the Invention

This invention relates to the field of mobile communications. More particularly, but not exclusively, it relates to extending radio messages according to a radio protocol for communicating between a mobile user equipment and a radio access network, such as the UMTS Terrestrial Radio Access Network (UTRAN).

In a UMTS network, the Radio Resource Control (RRC) protocol is used across the radio interface, i.e. between the user equipment and the radio access network. These protocol end points interact by exchanging protocol parameters, and by sending radio messages comprising of one or more information elements.

2. Description of the Related Art

As the radio protocols used in telecommunications systems are constantly developed and improved, for example to incorporate new features or to allow for corrections, mechanisms are used for extending messages of the radio protocol in future versions of the protocol. Accordingly, the radio messages may include new information element values, such as additional values or new values for more choices, and/or new information elements. In this way different versions of the protocol can be accommodated.

Special containers usually of variable length are used to accommodate so-called late extensions relating to a particular release of the radio protocol. A late protocol extension is an extension of a protocol release (N) that is introduced after the subsequent protocol release (N+1) is frozen. A release is frozen when implementations based on this release are in a final state of development or appear on the market, meaning that from this point in time only backwards compatible changes of the concerned release are accepted. By using these containers, the introduction of extensions to a particular release may be supported even after a subsequent release is frozen.

The containers introduce a length field, which indicates the total size of the extension data contained in the container. In this way partial decoding of the container is facilitated. Also, decoding of possible extensions included after the container is facilitated.

By using a container as described above, it is possible to foresee the inclusion of late extensions without knowing in advance what size is required for a future extension.

Also, if at a later stage a further extension needs to be added to a particular release, this can be directly included in the extension container.

All late extensions for a particular release are combined in one container, and for each different release a different container is used.

Details relating to the use of such containers in UMTS networks may be found in the 3GPP specification “Radio Resource Control Specification (RRC)”, 3GPP TS 25.331.

However, the disadvantage of introducing these extension containers is that they require additional space. Even if no extensions are included in the container, they each introduce an overhead of one or more bits in the message. If an extension is included, the containers introduce additional overheads.

### SUMMARY OF THE INVENTION

An aim of the invention is to alleviate the disadvantages described above and provide an improved method for accommodating and handling extension containers.

According to one aspect of the present invention, there is provided a method of communicating via a cellular communications network, with a mobile terminal communicating with network elements via radio messages according to a radio protocol, wherein the format of said radio messages includes a basic message corresponding to a first version of the radio protocol, extension blocks relating to subsequent versions of the radio protocol, and an extension container adapted to include extensions relating to more than one different versions of the radio protocol.

In this way it is not necessary to provide an extension container for every release of the radio protocol. Instead, a combined extension container can be used to accommodate extensions relating to more than one version of the radio protocol.

Preferably, a radio message includes only a single extension container. In this way the overhead introduced by providing extension containers may be significantly reduced.

According to another aspect of the present invention, there is provided a method of extending radio messages according to a radio protocol in a cellular communications network, wherein said messages are adapted for the use in the communication between a mobile terminal and network elements via radio messages, and wherein the format of said radio messages includes a basic message corresponding to a first version of the radio protocol, extension blocks relating to subsequent versions of the radio protocol, and an extension container including extensions relating to more than one different versions of the radio protocol.

According to another aspect of the present invention, there is provided a method of communicating via a cellular communications network using a radio protocol for communications between a mobile terminal and network elements, the method comprising the steps of: a mobile terminal processing a radio message according to a radio protocol received from network elements, wherein the format of said radio messages includes a basic message corresponding to a first version of the radio protocol, extension blocks relating to subsequent versions of the radio protocol, and an extension container adapted to include extensions relating to more than one different versions of the radio protocol; and the mobile terminal processing the extensions included in the extensions container up to the first extension the terminal does not comprehend.

According to another aspect of the present invention, there is provided a radio message for communicating via a cellular communications network using a radio protocol between a mobile terminal and network elements, wherein the radio message includes a basic message corresponding to a first version of the radio protocol, extension blocks relating to subsequent versions of the radio protocol, and an extension container adapted to include extensions relating to more than one different versions of the radio protocol.

According to another aspect of the present invention, there is provided a mobile terminal for communicating via a cellular communications network, the terminal being adapted to process a radio message according to a radio protocol received from network elements, wherein the format of said radio messages includes a basic message corresponding to a first version of the radio protocol, extension blocks relating to subsequent versions of the radio protocol, and an extension container adapted to include extensions relating to more than one different versions of the radio protocol; and wherein the terminal is further adapted to process the extensions included in the extensions container up to the first extension the terminal does not comprehend.

### BRIEF DESCRIPTION OF THE DRAWINGS

The above and other objects, features, and advantages of the present invention will be more apparent from the following detailed description taken in conjunction with the accompanying drawings, in which:

FIGS. 1 and 2 are schematic outlines of a mobile communications network, in which the present invention can be incorporated,

FIG. 3 is a schematic illustration of a radio protocol message according to the prior art;

FIG. 4 is a schematic illustration of a radio protocol message including an extension container according to the prior art;

FIG. 5 is a schematic illustration of a radio protocol message including multiple extension containers according to the prior art; and

FIG. 6 is a schematic illustration of a radio protocol message including an extension container according to one embodiment of the present invention.

### DETAILED DESCRIPTION OF THE PREFERRED EMBODIMENT

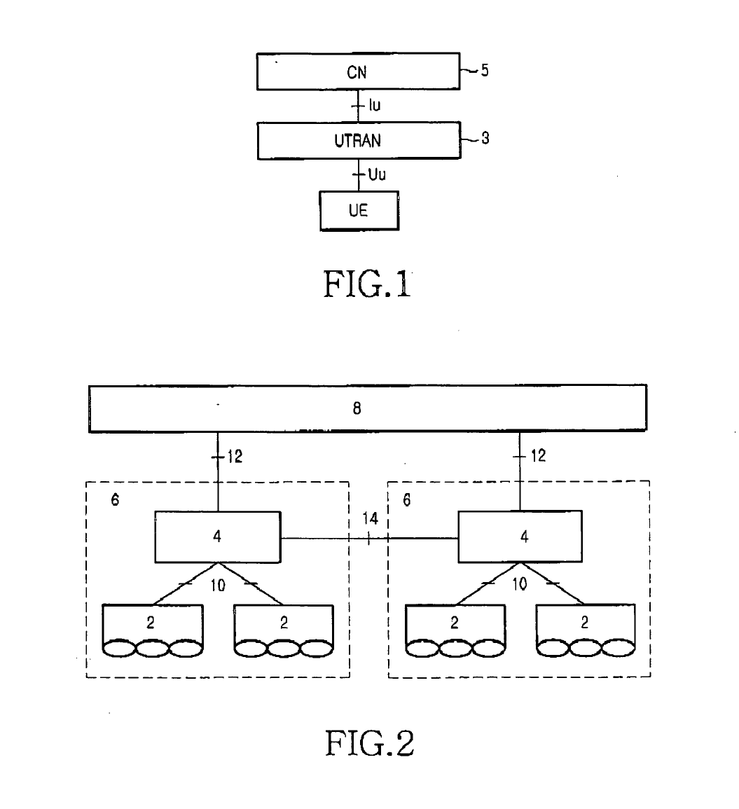

The typical architecture of a cellular radio system comprises mobile user equipments (UEs)1, a radio access network (RAN)3 and one or more core networks (CNs)5. As an example, FIG. 1 illustrates these basic elements for the Universal Mobile Telecommunications System (UMTS).

UMTS is a third generation radio network using wideband code division multiple access (W-CDMA) technology. More details about the UTRAN may be found in the 3GPP specification “UTRAN Overall Description”, 3GPP TS 25.401, and related specifications.

Communications between the UEs and the UTRAN is provided via the Uu interface (Uu), whereas the communication between the UTRAN and the core networks is done via the Iu interface (Iu).

FIG. 2 illustrates the architecture of a radio access network. The RAN comprises base stations 2, such as the so-called Node B's for the UTRAN, and radio network controllers 4 (RNC), also referred to as base station controllers (BSC). The base stations 2 handle the actual communication across the radio interface, covering a specific geographical area also referred to as a cell. Each RNC 4 controls the base stations 2 connected to it, and also includes other functionalities for tasks such as the allocation of radio resources, i.e. the local mobility. An RNC 4 is connected to one or more core networks 8 via the Iu interface 12, to a number of base stations 2 via the Iub interface 10 and possibly to one or more other RNCs 4 via the Iur interface 14.

In a UMTS network, the Radio Resource Control (RRC) protocol is used across the radio interface, i.e. between the UE and UTRAN. These protocol end points interact by exchanging protocol parameters, by sending messages comprising of one or more information elements.

As the radio protocols used in telecommunications systems are constantly developed and improved, for example to incorporate new features, it is envisaged that messages of the radio protocol can be extended.

In order to accommodate different, and possible future, versions of this protocol, a mechanism has been defined for extending these RRC messages with new information element values and/or new information elements.

There are two different kinds of protocol extensions: non-critical extensions (NCE) and critical extensions (CE).

In general, a receiver shall entirely reject a message including not-comprehended critical extensions and subsequently notify the sender. Therefore, a critically extended message need not comply with the format of a previous version, i.e. backward compatibility is not required. Instead, a critical extension of a message basically allows the defining a completely new version of the message, including additional information elements at any place of the message, or even removed or redefined information elements. Since the message version is indicated at the start of the message, a receiver immediately knows whether or not to reject the message.

In contrast, a receiver shall process a message including not-comprehended non-critical extensions (NCEs)—as if the extensions were absent. This means that in future versions of the protocol, non-critical values may be added to information elements, or non-critical information elements may be added to the message. The receiver shall be able to separate the non-critical extensions, which in the case of RRC is achieved by adding the non-critical extensions at the end of the message. A receiver decodes a message up to the first NCE that it does not comprehend.

Currently, the UMTS systems, as specified in the 3GPP specifications, are developed in phases. For each of these phases a complete set of specifications is developed. The phases currently defined include Release '99, REL-4, REL-5 and REL-6.

Accordingly, a radio message may include a basic message and several extensions, corresponding to one or more extensions defined in any of the releases.

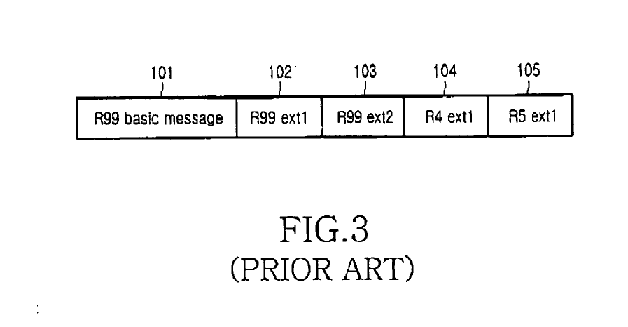

FIG. 3 illustrates a radio message including a basic message 101 as defined in the first release (Release '99), and further fields 102 to 105, including several extensions. Each consists of version # followed by info. In this example extensions 102 and 103 relate to Release '99, whereas extensions 104 and 105 relate to REL-4 and REL-5, respectively.

Whenever a protocol release is in development, changes to the RRC messages are tolerated. However, as soon as products for a certain release start approaching the market, such changes are no longer acceptable, as they would result in backwards incompatibilities. At this point in time the protocol release concerned is ‘frozen’, meaning that from this point in time all future changes are handled as extensions, according to the above-described mechanism.

FIG. 3 shows that the non-critical extension 104 introduced in REL-4 appear after the Release '99 extensions 101 and 103 of the message. This means that a transceiver according to a Release '99 implementation can easily ignore all non-critical extensions corresponding to REL-4 and later releases, as they are appended to the R99 extensions.

As long as the next release is not frozen, corrections and/or extensions may be inserted. This means, in the above-described example, that as long as the REL-4 is not frozen, R99 corrections/extensions may still be inserted prior to any REL-4 extensions. However, once products based on REL-4 enter the market, inserting so-called late corrections/extensions prior to the REL-4 would affect the products that are based on REL-4.

The reason for this is that the RRC messages apply an efficient encoding scheme, in which an information element does not appear in the encoded message, but it's meaning is implied by the location of the bits within the encoded message.

Accordingly if, in the example described above with reference to FIG. 3, a new Release '99 ext3 is to be inserted, a REL-4 implementation that was based on a specification version that did not include this will misinterpret the Release '99 ext3 bits as being the first bits of the REL-4 extension.

According to the 3GPP specifications, RRC messages are specified by means of Abstract Syntax Notation number One (ASN.1) and encoded in accordance with the Packed Encoding Rules (PER). This encoding mechanism has been selected in order to use the scarce radio resources as efficient as possible. A new mechanism was introduced to allow late extensions to an earlier release without affecting implementations according to later releases, i.e. the introduction of a special container for late corrections. The following extract from the R99 ASN.1 shows an example of such a variable length extensions container (VLEC).

-- ********************************************* ******
--
-- CELL UPDATE CONFIRM for CCCH
--
-- ***************************************************
CellUpdateConfirm-CCCH ::= CHOICE {

| | |
|---|---|
| r3 | SEQUENCE { |

-- User equipment IEs

| | |
|---|---|
| u-RNTI | U-RNTI, |

-- The rest of the message is identical to the o ne sent on DCCH.

| | |
|---|---|
| cellUpdateConfirm-r3 | CellUpdateConfirm-r3-IEs, |

| | |
|---|---|
| laterNonCriticalExtensions | SEQUENCE { |

| -- Container for additional R99 extensions | |
|---|---|
| cellUpdateConfirm-CCCH-r3-add-ext | BIT STRING OPTIONAL, |

| | |
|---|---|
| v4xyNonCriticalExtensions | SEQUENCE { |

cellUpdateConfirm-v4xyext

CellUpdateConfirm-v4xyext-IEs,

| | |
|---|---|
| nonCriticalExtensions | SEQUENCE {} OPTIONAL |

| | |
|---|---|
| } | OPTIONAL |

| | |
|---|---|
| } | OPTIONAL |

| }, | |
|---|---|
| later-than-r3 | SEQUENCE { |

| | |
|---|---|
| u-RNTI | U-RNTI, |
| rrc-TransactionIdentifier | RRC-TransactionIdentifier, |
| criticalExtensions | CHOICE { |

| | |
|---|---|
| r4 | SEQUENCE { |

| -- The rest of the message is identical to the one sent on DCCH. | | |
|---|---|---|
| cellUpdateConfirm-r4 | CellUpdateConfirm-r4-IEs, | |
| nonCriticalExtensions | SEQUENCE {} | OPTIONAL |

| }, | |
|---|---|
| criticalExtensions | SEQUENCE {} |

}

}

The main purpose of the VLEC is that it introduces a length field, indicating the total size of the late corrections contained in the container. In this way a receiver is able to skip extensions, which it cannot comprehend and subsequently read and decode following extensions situated after the extension container.

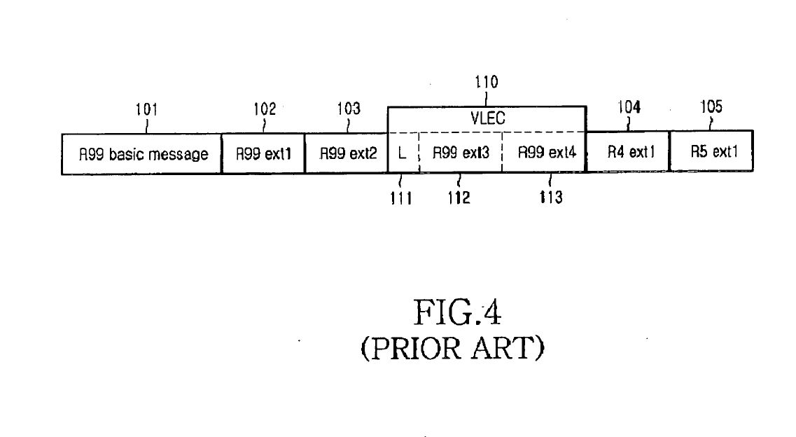

FIG. 4 illustrates a message similar to the message described above with reference to FIG. 3. However, the message of FIG. 4 includes a VLEC 110, which is included before the REL-4 extensions. This VLEC 110 includes a length field 111, and two late extensions to Release '99 (fields 112 and 113).

The length field 111 of VLEC 110 enables a REL-4 receiver to skip the late R99 extensions 112 and 113 that it has not implemented, but ensures that the REL-4 receiver is still be able to correctly decode the REL-4 extensions in field 104 that are placed after VLEC 110. In the above example, the length recorded in field 111 reflects the total size of the extensions contained in the VLEC 110, i.e. covering both R99ext3 and R99ext4 of fields 112 and 113.

Further details about the RRC protocol extension mechanisms are provided in the two 3GPP specifications “Radio Resource Control Specification (RRC)”, 3GPP TS 25.331 and “Guidelines and principles for protocol description and error handling”, 3GPP TS 25.921 (especially section 10.4.3.5). Both documents are herewith incorporated by reference.

Although a variable length extensions container allows implementations to skip not comprehended extensions, which are included in the VLEC, this comes at the cost of a length field. If no extensions are contained, the VLEC introduces an overhead of one or two bits, depending on whether it is introduced before or after the freezing of the concerned release. As soon as an extension is included, even if this only requires a single bit, the VLEC introduces an overhead of 9 or 10 bits, and 8 additional bits for the length field.

Therefore, the VLEC is not suitable for size critical messages.

When later releases are to be frozen, the question arises whether or not to introduce a VLEC container for each of the releases.

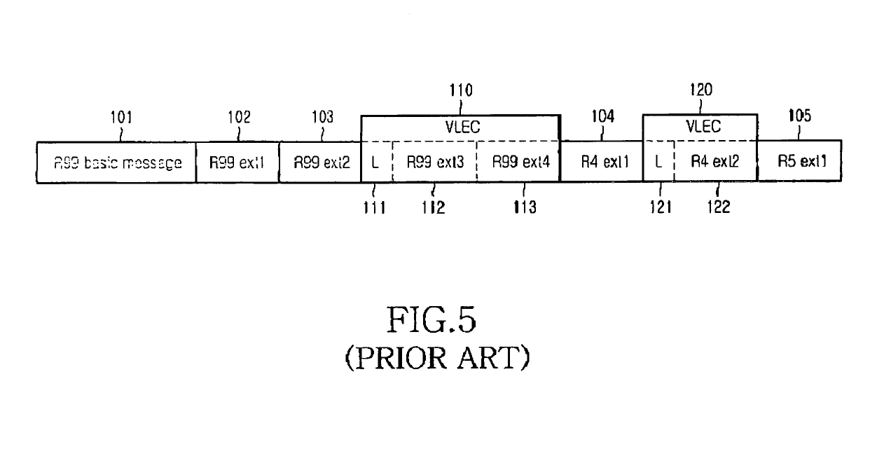

FIG. 5 illustrates a message including multiple VLECs, wherein each VLEC is reserved for late extensions of a particular release. Similar to the messages described above with reference to FIGS. 3 and 4, the message includes the basis message 101 and two extension blocks 102 and 103, respectively, both relating to Release '99 extensions. After these extension blocks a VLEC 110 is introduced which is reserved for possible late corrections of Release'99. This container includes length field 111 and two late extensions in fields 112 and 113, respectively. After the VLEC 110, the message includes an extension block 104 for REL-4, and another VLEC120, which is reserved for late extensions of REL-4. Again, the VLEC 120 includes a length field 121. In addition, VLEC 120 includes late extension 122. The second container 120 is positioned in front of block 105 including REL-5 extensions. The second container 120 is usually introduced upon freezing REL-5.

As described above, the drawback of this approach is the overhead increases whenever a VLEC is introduced.

According to the preferred embodiment of the present invention, the message includes only a single variable length extensions container in each message, and all late corrections or extensions are included in this single container, regardless of the release they correspond with. In this way the number of VLECs can be considerably reduced. The extensions are included in the order they were introduced. Thus, a REL-4 correction could appear before a REL-99 correction.

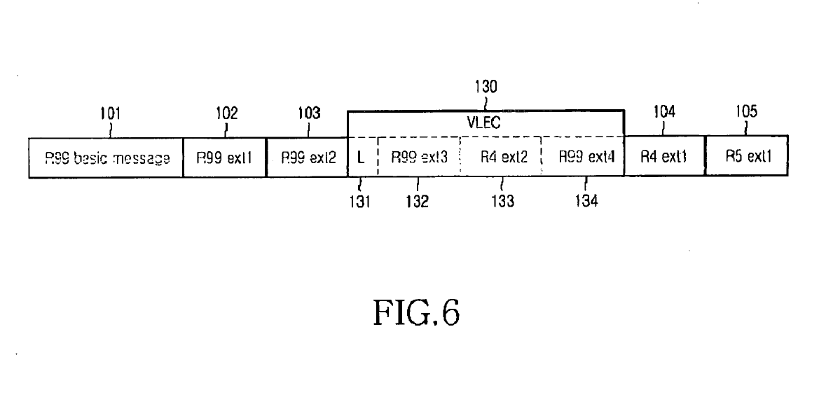

FIG. 6 illustrates a message having such a single VLEC. Again, the message includes the basis message 101 and the extension blocks 102 to 105, for extensions to Release '99, REL-4 and REL-5. After the two extension blocks 102 and 103 including the Release '99 extensions, a single VLEC 130 is introduced. This VLEC 130 may include extensions to different releases. The container 130 includes length field 131 and a first field 132 including a late extension to Release '99. In addition, VLEC 130 includes two further fields 133 and 134, including late extensions to REL-4 and Release '99, respectively.

In the described example, the order in which the late corrections/extensions are introduced are as follows: June 2003 for the third extension to Release '99 (R99ext3), September 2003 for the second extension to REL-4 (R4ext2) and March 2004 for the fourth late extension to Release '99 (R99ext4).

By introducing a single VLEC for all late extensions the overhead from multiple variable length extensions containers is avoided. Usually, a receiver decodes a message and the extensions in the VLEC up to the first extensions that it does not comprehend.

However, the extensions included in the container do not appear in the order of the protocol releases. Instead, they are ordered according to the date of the introduction of the late extension. Therefore, a late extension to the Release '99 could appear after a REL-4 or REL-5 correction, even though this is unlikely.

In the example described above with respect to FIG. 6 the last of the Release '99 extension (R99ext4 of field 134) is indeed included after a late extension to REL-4 (R4ext2 of field 133). As the extensions inside the VLEC do not have individual length fields, a receiver cannot skip individual extensions. The consequence is that a receiver may need to comprehend an REL-4 extension (R4ext2 in FIG. 6) in order to comprehend a Release '99 extension (R99ext4), as the R4ext2 appears in front of the R99ext4.

Therefore, for comprehending a late extension of a first release, which is only introduced after late extensions of a second, later release, a receiver may need some ASN.1 of the second release.

However, this is not considered to be seriously disadvantageous, as late corrections are rarely used. Generally, late corrections or extensions are only used in case there is a serious problem in the early release that still needs to be fixed. Also, since implementations for the later release typically enter the market after implementations for an earlier release, it is even more unlikely that the need for a late extension including a correction to the earlier release is discovered only after the need for a late correction for the later release.

If this problem occurs, it will be solved in the protocol specifications, so that implementation concerns are negligible.

It is to be understood that the expression ‘extensions’ used in this document is meant to include corrections and updates.

Whilst in the above-described embodiments radio messages based on Release '99 have been described, it is appreciated that the present invention is applicable to all UMTS releases.

Whilst the above-described embodiments have been described in the context of UMTS, it is appreciated that the present invention can also be applied to other similar systems.

It is to be understood that the embodiments described above are preferred embodiments only. Namely, various features may be omitted, modified or substituted by equivalents without departing from the scope of the present invention, which is defined in the accompanying claims.

1. A method of communicating via a cellular communications network, the method comprising:
communicating between a mobile terminal and a network element via radio messages according to a radio protocol,
wherein the format of said radio messages includes
a basic message portion corresponding to a first version of the radio protocol, and
blocks of extension data each relating to a subsequent version of the radio protocol, and
an extension container portion, characterised in that said extension container portion is adapted to include extension blocks relating to more than one subsequent version of the radio protocol.

2. A method according to claim 1, wherein said radio message includes a single extension container portion.

3. A method according to claim 1, wherein said extension container portion includes late extensions.

4. A method according to claim 1, wherein said extension container portion is of variable length.

5. A method according to claim 1, wherein the extensions in said extension container are ordered according to the date of introduction of the extensions.

6. A method of extending radio messages according to a radio protocol in a cellular communications network,
wherein said messages are adapted for the use in the communication between a mobile terminal and network elements via radio messages, and
wherein the format of said radio messages includes
a basic message corresponding to a first version of the radio protocol,
extension blocks relating to subsequent versions of the radio protocol, and
an extension container including extensions relating to more than one different version of the radio protocol.

7. A method of communicating via a cellular communications network using a radio protocol for communications between a mobile terminal and a network element, the method comprising the steps of:
processing a radio message received from network elements at a mobile terminal according to a radio protocol, wherein
the format of said radio messages includes
a basic message portion corresponding to a first version of the radio protocol, blocks of extension data each relating to a subsequent version of the radio protocol, and
an extension container portion adapted to include extension blocks relating to more than one subsequent version of the radio protocol; and wherein
the mobile terminal processes the extensions included in the extensions container up to the first extension the terminal does not comprehend.

8. A method according to claim 7, wherein the mobile terminal skips any not-comprehended extensions in the extension container and continues to process any portions of the message which are arranged after the extension container.

9. A method according to claim 8, wherein the extension container includes a length field to indicate the total length of the extension container.

10. A method according to claim 9, wherein the mobile terminal uses the length field in order to skip any not-comprehended extensions in the extension container.

11. A method according to claim 7, wherein said radio protocol is the RRC protocol according to the UMTS standards.

12. A network element for communicating via a cellular communications network, adapted to communicate according to the method as claimed in claim 1.

13. A mobile terminal for communicating via a cellular communications network, adapted to communicate according to the method as claimed in claim 1.

14. A mobile terminal for communicating via a cellular communications network, adapted to communicate according to the method as claimed in claim 7.

15. A radio message for communicating via a cellular communications network using a radio protocol, the radio message comprising:
a basic message portion corresponding to a first version of the radio protocol,
extension blocks relating to subsequent releases of the radio protocol, and
an extension container portion, characterised in that said extension container is adapted to include extensions relating to more than one different release of the radio protocol.

16. A mobile terminal for communicating via a cellular communications network, the terminal being adapted to process a radio message according to a radio protocol received from a network element, wherein
the format of said radio messages includes
a basic message portion corresponding to a first version of the radio protocol,
extension blocks relating to subsequent versions of the radio protocol, and
an extension container portion adapted to include extensions relating to more than one subsequent version of the radio protocol;
and wherein the mobile terminal is further adapted to process the extensions included in the extension container up to the first extension the terminal cannot interpret.
